(19) United States
(12) Patent Application Publication
(10) Pub. No.: US 2025/0114269 A1
(43) Pub. Date: Apr. 10, 2025

(54) PROSTATE MASSAGE DEVICE

(71) Applicant: Jun Hyeong YUN, Gumi-si, Gyeongsangbuk-do (KR)

(72) Inventor: Jun Hyeong YUN, Gumi-si, Gyeongsangbuk-do (KR)

(21) Appl. No.: 18/832,916

(22) PCT Filed: Jan. 18, 2023
(86) PCT No.: PCT/KR2023/000842

§ 371 Date: Jul. 24, 2024

(30) Foreign Application Priority Data
Jan. 26, 2022 (KR) 10-2022-0011217
Mar. 2, 2022 (KR) 10-2022-0026665

(51) Int. Cl. A61H 15/00

(52) U.S. Cl. CPC A61H 15/0078; A61H 2015/0028; A61H 2201/0149; A61H 2201/1215; A61H 2201/149; A61H 2201/1669; A61H 2205/085

(57) ABSTRACT

A prostate massage device (200) of the present invention includes: a base body (210); a rail support portion (230) formed on the base body; a rail (220) which is arranged to be inclined and supported at the rail support portion with a fixing shaft (231) interposed therebetween so that one end thereof is rotatable; a tension spring (233) which is biased to one end of the rail to be coupled to the fixing shaft and to lift the other end of the rail; a massage body (240) which moves along the rail; an arm (250) of which one end is linked with the massage body; an arm driving motor (260) which is linked with the other end of the arm to move the arm back and forth; and an upper cover (270) having a linear-type groove (271) so as to partially expose the massage body.

### TECHNICAL FIELD

The present invention relates to a prostate massage device, and more particularly, to a massage device that improves massage efficiency to allow blood to smoothly flow between an anus and a genital organ of a human body, thereby preventing prostate disease in men and preventing urinary incontinence disease in women.

### BACKGROUND ART

A prostate and a urinary tract of a human body are located in a perineum that is located in a middle portion between an anus and a genital organ, and it is known that, when the perineum is massaged by applying appropriate vibration or pressure thereto, functional decrease or disease in the prostate and the urinary tract can be prevented.

The example of a general prostate massage device is described in Korean Patent Registration No. 10-1525585.

As illustrated in FIGS. 1 and 2, a prostate massage device 100 according to the related art includes a bottom frame 50 and a middle frame 60 on both sides thereof such that the prostate massage device 100 is supported on a floor of a room and is connected to an upper handle rod 70 by vertical shafts 40 and 41 such that the prostate massage device 100 is integrally formed.

A portion of a circular wheel 12 of a rotatable body 10 having a diameter ranging from 20 cm to 30 cm protrudes outward from a horizontal surface of a chair plate 30 between the middle frames 60, and the protruding wheel portion has a structure that may be rotated by a body weight.

Further, rails 61 are formed at upper ends of the middle frames 60 on both sides, and the chair plate 30 horizontally installed between the middle frame 60 and the upper handle rod 70 has a hole 31 formed in a middle portion thereof and having the form of a long axis hole having a diameter ranging from 15 cm to 30 cm. The wheel protruding portion of the rotatable body 10 supported on the middle frame 60 is formed in the hole 31 to protrude 1 cm to 3 cm upward from the horizontal surface of the chair plate 30. A structure in which rail holders 32 are fixed to bottom portions of both sides of the chair plate 30 and the rail holders 32 on both sides thereof surround the rails 61 formed at upper ends of the middle frames 60 is formed.

The structure is operated so that a user sits on the chair plate 30, holds the upper handle rod 70, and allows the chair plate 30 to reciprocate in a front-rear direction, and thus the wheel protruding portion of the rotatable body 10 can press and massage the perineum between the anus and the genital organ of the human body.

Further, the middle frame 60 has the rail 61 formed at an upper central portion thereof and is configured such that the rail holder 32 of the chair plate 30 covers the rail 61 to prevent the rail holder 32 from escaping from the rail 61. Screw joints 33 in the form of concave grooves are formed in both sides of a bottom surface of the chair plate 30 so that the bottom rail holder 32 is fixed to the chair plate 30.

Meanwhile, the rotatable body 10 is connected to a fixing shaft 22 connected to a bottom fixing plate 23 and a U-shaped support 21 having an accommodating groove 21a accommodating the fixing shaft 22, to constitute a shock absorbing unit. A structure in which an elastic spring 24 is embedded in the fixing shaft 22 connected to the bottom fixing plate 23 and pressed by a lower end of the U-shaped support 21 is formed. An upper end 22a of the fixing shaft 22 is located in a cylindrical shape inside the accommodating groove 21a formed at a central portion of the U-shaped support 21. Thus, a structure in which, when the user sits on the chair plate 30 and allows the chair plate 30 to reciprocate in a front-rear direction while pressing the protruding portion of the rotatable body 10, the rotatable body 10 is pushed about 2 mm to about 10 mm downward and then returns to an original position thereof with elasticity is formed.

In the rotatable body 10, a circular wheel 12 may be made of a metal material such as copper having high thermal conductivity, and a hot water inlet 14 and a rubber cap 15 may be formed on one side of the circular wheel 12.

In the prostate massage device 100 according to the related art as described above, because the user should sit on the chair plate 30 and allow the chair plate 30 to reciprocate along the rail 61 by himself or herself, use thereof is inconvenient.

Further, because an elastic load of the rotatable body 10 that performs a massage action is achieved only by an action of the elastic spring 24, massage compression strength is constant regardless of the position of the chair plate 30, and thus a touch sense and efficiency of the massage are decreased.

### DISCLOSURE

### Technical Problem

The present invention is created to solve the above problems, and the purpose of the present invention is directed to providing a prostate massage device having a simple structure capable of performing massage while varying compression strength.

The another purpose of the present invention is directed to providing a prostate massage device used while a user adjusts massage compression strength.

The still another purpose of the present invention is directed to providing a prostate massage device having improved tactile quality of a massage roller contact part.

### Technical Solution

To achieve the purposes, a prostate massage device according to the present invention includes a base body, a rail support formed on the base body, a rail disposed to be inclined and supported on the rail support using a fixing shaft about which one end thereof is rotatable, a massage bundle that moves along the rail, an arm of which one end is linked to the massage bundle, an arm driving motor linked to the other end of the arm to move the arm forward or backward, and an upper plate cover having a linear groove so that a portion of the massage bundle is exposed.

The massage bundle includes a moving bundle to which the one end of the arm is linked, a shock absorbing rod installed upright on the moving bundle, and a massage roller rotatably coupled to an upper end of the shock absorbing rod, and a portion of a circumferential surface of the massage roller is exposed to outside of the linear groove formed in the upper plate cover.

Further, a first elastic member may be coupled to the fixing shaft and elastically supported on the one end of the rail to lift up the other end of the rail.

Further, a rail support bundle that selectively elastically supports or selectively supports the other end of the rail may be provided on the base body.

Further, the rail support bundle may include a cylindrical chamber that selectively supports the other end of the rail, a second elastic member that is mounted inside the cylindrical chamber and selectively elastically supports the other end of the rail, a slit-shaped groove formed at a lower end of the chamber, and a slide plate that moves forward or backward by a driving motor inserted into the slit-shaped groove, and as the slide plate moves forward or backward, an upper end of the second elastic member protrudes upward from the cylindrical chamber or is moved backward into the cylindrical chamber.

### Advantageous Effects

The present invention relates to a prostate massage device including a base body, a rail support formed on the base body, a rail disposed to be inclined and supported on the rail support using a fixing shaft about which one end thereof can rotate, a first elastic member coupled to the fixing shaft and elastically supported on one end of the rail to lift up the other end of the rail, a massage bundle that moves along the rail, an arm of which one end is linked to the massage bundle, an arm driving member linked to the other end of the arm to move the arm forward or backward, an upper plate cover having a linear groove so that a portion of the massage bundle is exposed, and a rail support bundle formed on the base body to selectively elastically support or selectively support the other end of the rail.

The massage bundle includes a moving bundle to which the one end of the arm is linked, a shock absorbing rod installed upright on the moving bundle, and a massage roller rotatably coupled to an upper end of the shock absorbing rod, and a portion of a circumferential surface of the massage roller is exposed to the outside of the linear groove formed in the upper plate cover. Thus, massage can be performed while varying compression strength according to the position of the massage roller.

Further, the rail can be selectively elastically supported using the rail support bundle, and thus a user can use the prostate massage device while appropriately adjusting massage compression strength.

Further, since the massage bundle moves along the rail in a state in which an elastic member having a tension spring elastically supports the one end of the rail at an angle, the compression strength of the massage roller can vary according to the position of the rail.

That is, even when elastic repulsive forces of the tension spring and the spring configured in the shock absorbing rod interact, according to the lever principle, the compression strength of the massage roller on an upper side of the rail is relatively small, and a compression strength of the massage roller on a lower side of the rail is relatively large. Thus, tactile strength and quality of a human body contact part of the massage roller can be improved.

### DESCRIPTION OF DRAWINGS

FIG. 1 is a three-dimensional view of a prostate massage device according to the related art.

FIG. 2 is a cross-sectional view of a rotatable body of the prostate massage device according to the related art.

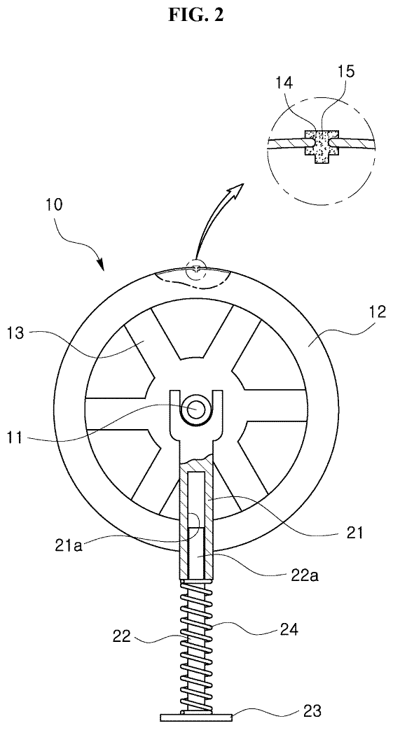

FIG. 3 is a three-dimensional view of a main part of a prostate massage device according to the present invention.

FIG. 4 is a plan view of the prostate massage device according to the present invention.

FIG. 5 is a front view of the prostate massage device according to the present invention.

FIG. 6 is a side view of the prostate massage device according to the present invention.

FIG. 7 is a perspective view of a main part illustrating one end of a rail of the prostate massage device according to the present invention.

FIG. 8 is a perspective view of a main part in a coupling state of a massage bundle and the rail of the prostate massage device according to the present invention.

FIG. 9 is a view illustrating a state before a rail support bundle of the prostate massage device is driven according to the present invention.

FIG. 10 is a view illustrating a state after the rail support bundle of the prostate massage device is driven according to the present invention.

FIG. 11 is a three-dimensional view of a main part in a state in which the massage bundle of the prostate massage device according to the present invention is moved downward.

FIG. 12 is a plan view illustrating a state in which the massage bundle of the prostate massage device according to the present invention is moved downward.

### DESCRIPTION OF REFERENCE NUMERALS

200: Prostate massage device
210: Base body
220: Rail
221: Bearing
230: Rail support
231: Fixing shaft
233,245,291: Spring
240: Massage bundle
241: Moving bundle
242: Shock absorbing rod
243: Massage roller
250,288: Arm
255: Eccentric cam
260: Arm driving motor, 270: Upper plate cover
280: Rail support bundle
281: Cylindrical chamber
282: Slit-shaped groove
286: Motor
287: Cam
290: Slide plate

### BEST MODE

A prostate massage device according to the present invention includes a base body 210, a rail support 230 formed on the base body 210, a rail 220 disposed to be inclined and supported on the rail support 230 using a fixing shaft 231 about which one end thereof may rotate, a massage bundle 240 that moves along the rail 220, an arm 250 of which one end is linked to the massage bundle 240, an arm driving motor 260 linked to the other end of the arm 250 to move the arm 250 forward or backward, and an upper plate cover 270 having a linear groove 271 so that a portion of the massage bundle 240 is exposed, wherein the massage bundle 240 includes a moving bundle 241 to which the one end of the arm 250 is linked, a shock absorbing rod 242 installed upright on the moving bundle 241, and a massage roller 243 rotatably coupled to an upper end of the shock absorbing rod 242, and a portion of a circumferential surface of the massage roller 243 is configured to protrude and be exposed to the outside of the linear groove 271 formed in the upper plate cover 270.

### MODES OF THE INVENTION

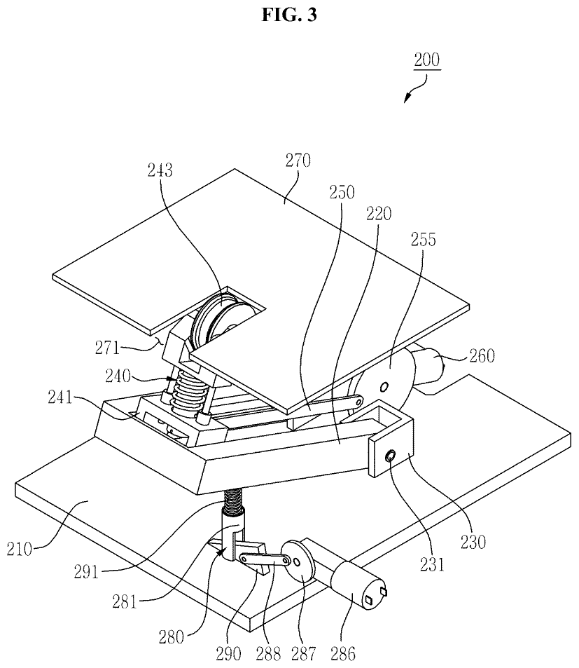

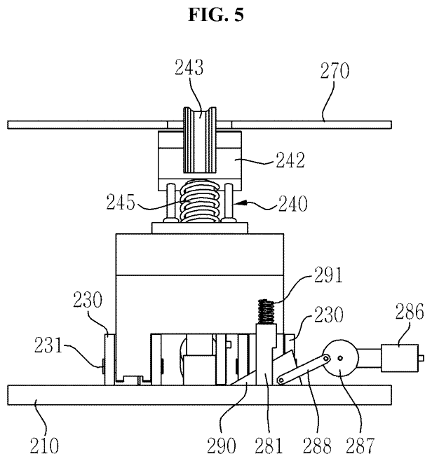

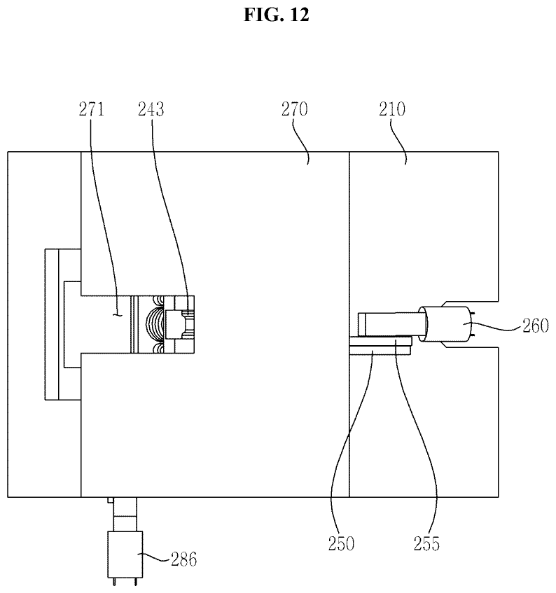

Hereinafter, a technical configuration and operational effects of a prostate massage device 200 according to the present invention will be described in detail with reference to FIGS. 3 to 12.

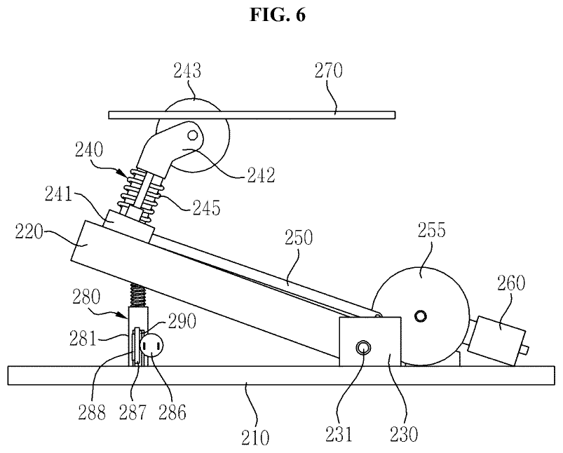

As illustrated in FIGS. 3 and 6, a prostate massage device 200 according to the present invention includes a base body 210, a rail 220, a rail support 230, a massage bundle 240, an arm 250, an arm driving motor 260 constituting an arm driving member, an upper plate cover 270, and a rail support bundle 280.

As an example, the prostate massage device 200 according to the present invention is formed in a hexahedral shape having a horizontal width of 400 mm, a vertical width of 300 mm, and a height of 100 mm and is formed such that an entire side portion thereof is shielded by a cover, but for convenience of description, a structure in which the side portion is open will be described with reference to the accompanying drawings.

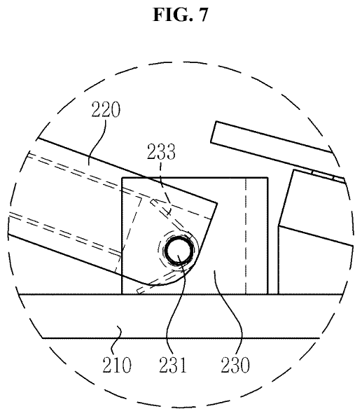

The rail supports 230 are fixed on both sides of a bottom of the base body 210, and one end of the rail 220 is fixed to each of the rail supports 230 while being disposed to be inclined, by inserting the fixing shaft 231. As illustrated in FIG. 7, an elastic member (tension spring 233) that is elastically supported by one end of the rail 220 so that the other end of the rail 220 is lifted up is coupled to the fixing shaft 231. Due to an action of the tension spring 233, an elastic force that allows the other end of the rail 220 to rotate about the fixing shaft 231 upward is formed.

As illustrated in FIG. 6, the massage bundle 240 includes a moving bundle 241, a shock absorbing rod 242 installed in the moving bundle 241, a massage roller 243 coupled to an upper end of the shock absorbing rod 242, and a first elastic member 245 fitted between the shock absorbing rod 242 and the moving bundle 241. The shock absorbing rod 242 has an upper end that is bent at about 30 degrees to 40 degrees for stable operation of the massage roller 243. Further, the shock absorbing rod 242 may be formed using a widely-known shock absorber, and the massage roller 243 may be made of a material including silicone.

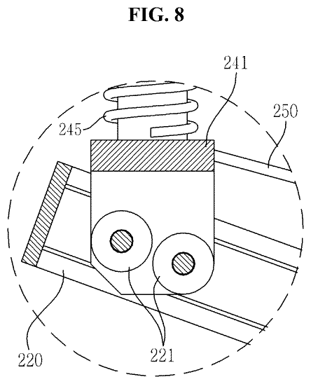

The moving bundle 241 constituting the massage bundle 240 may move along the rail 220 as illustrated in FIG. 8 and may move smoothly without friction by a bearing 221 disposed on the rail 220.

Further, the moving bundle 241 is linked and fixed to one end of the arm 250, and the other end of the arm 250 is fixed to an eccentric cam 255. The eccentric cam 255 may be formed to be rotatable by the arm driving motor 260 and may move the arm 250 forward or backward by rotation of the eccentric cam 255. A gear or the like that is not illustrated may be interposed between the eccentric cam 255 and the arm driving motor 260 so that the eccentric cam 255 may be rotatably formed.

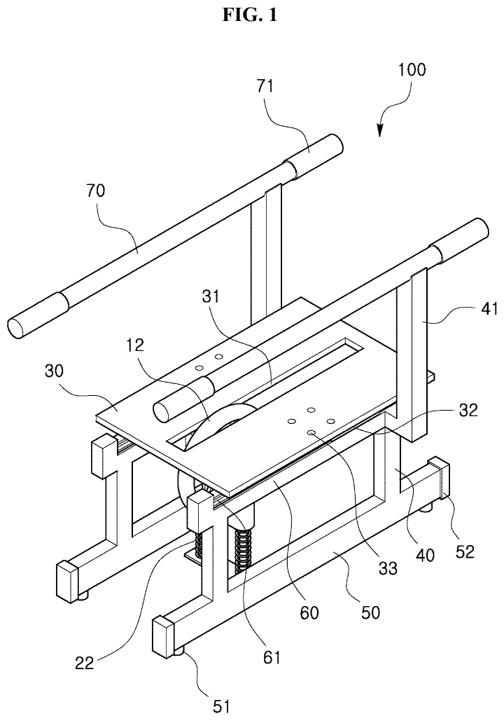

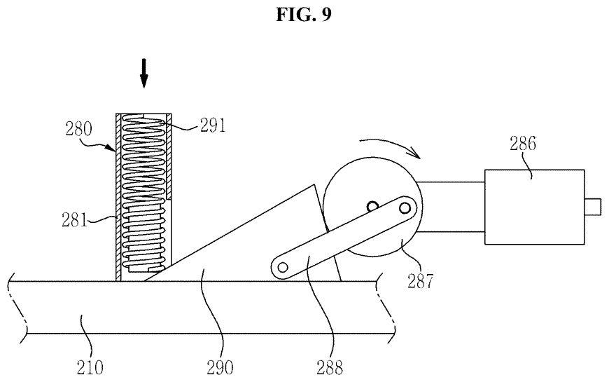

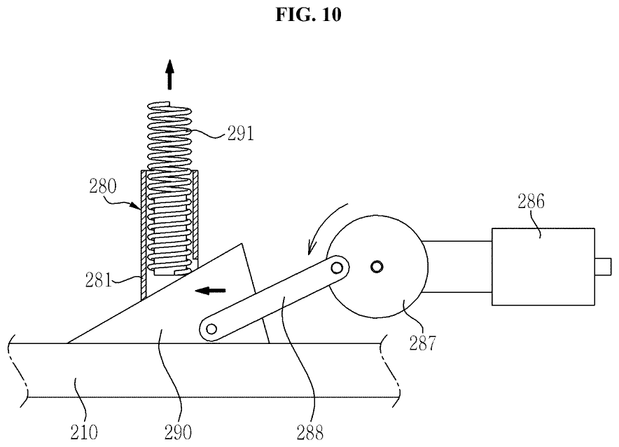

Meanwhile, as illustrated in FIGS. 1, 6, 9, 10, and 11, the rail support bundle 280 configured to selectively elastically support or selectively support the other end of the rail 220 is formed on the base body 210. The rail support bundle 280 includes a cylindrical chamber 281 that selectively support the other end of the rail 220, a second elastic member 291 that is mounted inside the cylindrical chamber 281 and selectively elastically supports the other end of the rail 220, and a slit-shaped groove 282 formed at a lower end of the chamber 281. The second elastic member 291 is mounted within the chamber 281. Thus, as illustrated in FIG. 9, the second elastic member 291 may be pushed by a slide plate 290 that is inclined to be moved forward toward the slit-shaped groove 282 and may be lifted up to an upper side of the chamber 281 inside the chamber 281, and as illustrated in FIG. 10, when the slide plate 290 is drawn from the slit-shaped groove 282, the second elastic member 291 is moved backward into the chamber 281.

The slide plate 290 is moved forward toward the slit-shaped groove 282 formed in the chamber 281 using a cam 287 driven by a motor 286 and an arm 288 eccentrically fixed to the cam 287.

As the rail support bundle 280 is configured above, when a user wants to increase the compression strength of the massage bundle 240, the second elastic member 291 protrudes to elastically support the rail 220 from a lower side as illustrated in FIGS. 1 and 9.

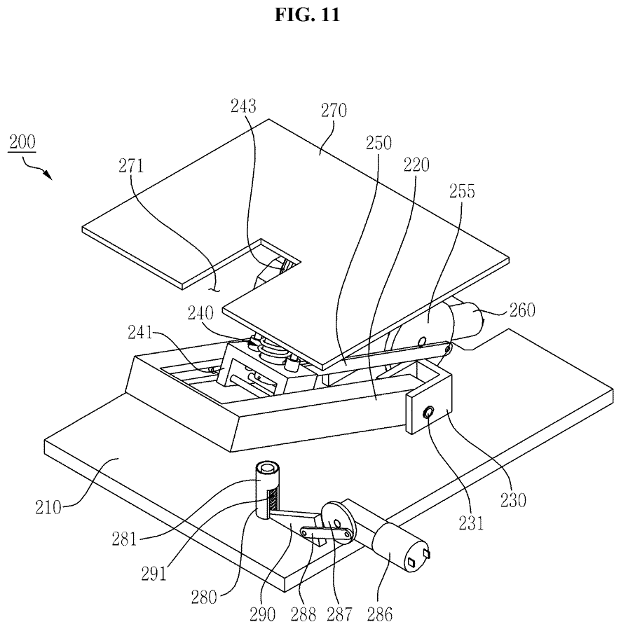

In contrast, when the user wants to decrease the compression strength of the massage bundle 240, the second elastic member 291 is moved backward into the chamber 281 to prevent the rail 220 and the second elastic member 291 from being in contact with each other as illustrated in FIGS. 10 and 11. In a state in which the second elastic member 291 is moved backward into the chamber 281, the compression strength of the massage bundle 240 is relatively weak, but the rail 220 comes into contact with the cylindrical chamber 281 and is lowered only to a stopper position.

Meanwhile, the upper plate cover 270 includes a linear groove 271 from which a portion of a circumferential surface of the massage roller 243 constituting the massage bundle 240 protrudes and is exposed. A portion of the circumferential surface of the massage roller 243 that protrudes and is exposed from the linear groove 271 rotates while in contact with a human body of the user and thus stimulate the perineum of the user. A height of the massage roller 243 protruding and exposed from the linear groove 271 may be appropriately regulated using the upper plate cover 270 or a separate stopper (not illustrated) provided on a lower surface of the upper plate cover 270.

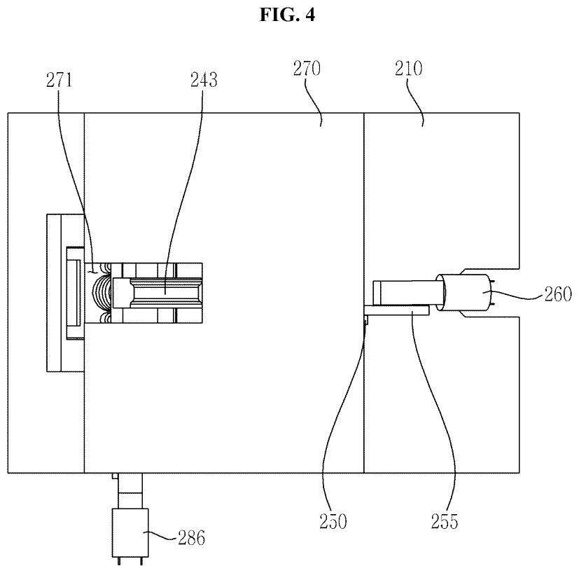

In the prostate massage device 200 according to the present invention, when the user sits on the upper plate cover 270, as illustrated in FIGS. 3 and 4, in a state in which the massage roller 243 is located on the upper side, the massage roller 243 exposed through the linear groove 271 of the upper plate cover 270 is repeatedly moved downward according to driving of the arm driving motor 260 and presses and moves the perineum of the user to perform the massage.

In particular, in the present invention, even when elastic repulsive forces of the tension spring 233 and the first elastic member 245 formed in the shock absorbing rod 242 interact, the massage bundle 240 moves along the rail 220 in a state in which the tension spring 233 elastically supports one end of the rail 220 to be inclined. Thus, according to the lever principle, a relatively small compression strength of the massage roller 243 is applied to an upper side of the rail 220, a relatively large compression strength of the massage roller 243 is applied to a lower side of the rail 220, and thus, in a process of moving and rotating the roller, a tactile strength and quality of a body contact portion of the roller may be improved.

Further, since the rail 220 may be selectively elastically supported using the rail support bundle 280, the compression strength of the massage may be appropriately adjusted according to user's preference in a massage process.

Further, to further improve a massage function, a vibration device (not illustrated) may be further included in the moving bundle 241.

The prostate massage device 200 according to the present invention is not limited to the illustrated drawing structure and description, but may be variously modified and implemented within the scope of the appended claims and purpose of the present invention.

### INDUSTRIAL APPLICABILITY

A massage device having a simple structure that can perform massage while varying a compression strength is provided.

1. A prostate massage device comprising:
a base body;
a rail support formed on the base body;
a rail disposed to be inclined and supported on the rail support using a fixing shaft about which one end thereof is rotatable;
a massage bundle that moves along the rail;
an arm of which one end is linked to the massage bundle;
an arm driving motor linked to the other end of the arm to move the arm forward or backward; and
an upper plate cover having a linear groove so that a portion of the massage bundle is exposed,
wherein the massage bundle includes a moving bundle to which the one end of the arm is linked, a shock absorbing rod installed upright on the moving bundle, and a massage roller rotatably coupled to an upper end of the shock absorbing rod, and
a portion of a circumferential surface of the massage roller is exposed to outside of the linear groove formed in the upper plate cover.

2. The prostate massage device of claim 1, wherein an eccentric cam is interposed between the arm and the arm driving motor.

3. The prostate massage device of claim 1, wherein a spring is further included in the shock absorbing rod.

4. The prostate massage device of claim 1, wherein a rail support bundle configured to selectively elastically support or selectively support the other end of the rail is formed on the base body.

5. The prostate massage device of claim 1, wherein a first elastic member is coupled to the fixing shaft and elastically supported on the one end of the rail to lift up the other end of the rail.

6. The prostate massage device of claim 4, wherein the rail support bundle includes:
a cylindrical chamber configured to selectively support the other end of the rail;
a second elastic member mounted inside the cylindrical chamber and configured to selectively elastically support the other end of the rail;
a slit-shaped groove formed at a lower end of the chamber; and
a slide plate configured to move forward or backward by a driving motor inserted into the slit-shaped groove, and
as the slide plate moves forward or backward, an upper end of the second elastic member protrudes upward from the cylindrical chamber or is moved backward into the cylindrical chamber.
